(19) United States
(12) Patent Application Publication
(10) Pub. No.: US 2005/0252374 A1
(43) Pub. Date: Nov. 17, 2005

(54) Adsorbent bed and process for removal of propane from feed streams

(76) Inventors: Gregory William Henzler, East Amherst, NY (US); Alan Barnard Stewart, Snyder, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/843,590

(22) Filed: May 12, 2004

(51) Int. Cl. B01D 53/02

(52) U.S. Cl. 95/96; 95/143; 96/132

(57) ABSTRACT

This invention relates to an apparatus and process for the removal of impurities, such as propane, from gas streams. A preferred apparatus and process thereof uses a multilayered adsorbent bed wherein a discrete layer of silicalite adsorbent is used to remove propane and other impurities from air.

### FIELD OF THE INVENTION

This invention relates to the removal of propane from gas streams, and more particularly to the removal of propane from feed air streams prior to cryogenic air separation.

### BACKGROUND OF THE INVENTION

Air prepurifiers are designed for complete or partial removal of water, carbon dioxide, hydrogen, propane, acetylene, C₄+ hydrocarbons and other contaminants. Air prepurification can be accomplished using pressure swing adsorption (PSA), temperature swing adsorption (TSA) or a combination of both (TSA/PSA) incorporating either a single adsorbent or multiple adsorbents. When more than one adsorbent is used, the adsorbents may be configured as discrete layers, as mixtures, composites or combinations of these. Impurities such as H₂O and CO₂ are commonly removed from air using two adsorbent layers in a combined TSA/PSA process. Normally, a first layer of activated alumina is used for water removal and a second layer of 13X molecular sieve is used for CO₂ removal.

The propane concentration in air is generally about 0.3 to 2.0 ppm. The typical case for propane (C₃H₈) is in the range from about 0-1 ppm with 1 ppm being generally the very high concentration although there could be locations where the propane concentration is higher than 1 ppm. For safe operation in a cryogenic air separation unit (ASU), it is preferred to have a propane level of less than 0.1 ppm in the feed stream. While current prepurifier designs (PSA) remove virtually all of the acetylene and C₄+ hydrocarbons, they generally only remove between about 66% to 71% of the propane, often times leaving more than 0.1 ppm present in gas streams being fed to an ASU. In such a situation, one must either increase the oxygen delivery pressure to 40 psig or higher in order to boil liquid oxygen to dryness in the primary heat exchanger, or where the end use application require delivery at less than 40 psig (where propane is insoluble in liquid oxygen), add a liquid oxygen percolating product boiler to the ASU. These alternatives increase both capital and operating costs. Thus there is a need for air prepurification systems that ensure that propane is removed from feed streams such that less than 0.1 ppm propane remains.

Jain and Tseng, in U.S. Pat. No. 5,914,455, describe a process which uses two adsorbent beds for the removal of moisture and carbon dioxide. The first bed is a pressure swing adsorption system for removing moisture and carbon dioxide from the feed air. The second bed is a thermal swing adsorption bed in which the dried air is passed through a bed of carbon dioxide selective adsorbent to remove the remaining carbon dioxide. The feed air may be passed through beds of hydrogen and carbon monoxide oxide catalysts between the first and second steps to convert any hydrogen and carbon monoxide in the feed air to water and carbon dioxide, these products being removed in the second step. The feed air may be optionally passed through a layer of a hydrocarbon selective adsorbent between the first and second steps to remove hydrocarbons such as ethylene, propylene, and propane.

Kratz et al in U.S. Pat. No. 5,840,099, disclose a process for the removal of water, carbon dioxide, ethane and C₃+ hydrocarbons from gas streams using an adsorbent that is basic and mesoporous (i.e. compounds which have moderately small pores providing a surface less than 500 m²/g). Mesoporous adsorbents which are disclosed include zinc oxide, magnesium oxide and activated alumina.

In Jain, U.S. Pat. No. 5,232,474, carbon dioxide is removed from a gas stream containing at least 250 ppm of carbon dioxide by pressure swing adsorption in an alumina adsorption bed that is sized sufficiently large to remove at least 75 mole per cent of the carbon dioxide in the gas. Moisture is also removed from the gas stream in a second bed of zeolite.

Addiego in U.S. Pat. No. 6,004,896 teaches a technique for altering the properties of an adsorbent bed so as to cause adsorption and retention of the hydrocarbons in a stream at an elevated temperature. A molecular sieve is contacted by an anionic agent to modify the acid sites in the sieve.

Kumar, in U.S. Pat. No. 4,711,645, uses consecutive beds of activated alumina and molecular sieve adsorbent to remove moisture and carbon dioxide, respectively from a feed air stream.

Hampson and Rees (J. Chem. Soc. Faraday Trans., 1993, 89(16), 3169-3176) studied the adsorption of ethane, propane and mixtures thereof on silicalite and NaY molecular sieve.

Reyhing (Linde Reports on Science and Technology, No. 36 (1983)) discloses the removal of hydrocarbons from process air to air separation plants through the use of molecular sieve adsorbents.

Ackley et al in U.S. Pat. No. 6,027,548 disclose a process and apparatus for the separation of a light component from a heavy component in a feed stream in which an adsorbent bed having either a mixture of adsorbents or a composite adsorbent material is used. The mixture or composite includes at least one adsorbent that is comparatively strong and the other is comparatively weak with respect to the heavy component. NaY is disclosed as a comparatively strong adsorbent and alumina is disclosed as a comparatively weak adsorbent.

Leavitt in U.S. Pat. No. 5,769,928 discloses a process and apparatus for the separation of a light component from a heavy component in a feed stream in which an adsorbent bed having discrete layers of adsorbents, including at least one adsorbent that is comparatively strong and the other is comparatively weak with respect to the heavy component. NaY is disclosed as a comparatively strong adsorbent and alumina is disclosed as a comparatively weak adsorbent.

In spite of the above, there remains a need in the art for an improved prepurification process for the removal of propane and other contaminants from feed air prior to cryogenic air separation.

### OBJECTS OF THE INVENTION

It is therefore an object of the invention to provide for an improved apparatus and method for the removal of propane from gas streams.

It is a further object of the invention to provide for an improved prepurification apparatus and process for the removal of propane from feed air prior to cryogenic air separation.

### SUMMARY OF THE INVENTION

This invention comprises an apparatus and process for the effective removal of water, carbon dioxide, propane and optionally hydrogen and/or carbon monoxide from gas streams. A preferred apparatus comprises a multilayered adsorbent bed wherein a discrete layer of silicalite adsorbent is used.

A preferred process comprises passing a feed stream including propane over a multilayered adsorbent bed that includes a discrete layer of silicalite for the adsorption of propane.

More particularly, the invention comprises an adsorbent bed comprising at least two adsorbents wherein one of the adsorbents is silicalite.

In a preferred embodiment the at least two adsorbents are in discrete layers, in a mixed layer, in a composite particle or in a combination of these.

In an alternative embodiment another of the adsorbents could be sodium yttrium (NaY), NaX (or 13X which is a sodium form of the Type X crystal structure) or mixtures thereof.

In an alternative embodiment, activated alumina is within the bed, preferably in a discrete layer, along with NaY or CDX which is composite material of 40% NaY molecular sieve and 60% activated alumina.

In a preferred embodiment the bed is configured for either a vertical, horizontal or radial flow of a feed gas.

In a preferred embodiment, the bed comprises a first layer of activated alumina; a second layer of NaX, NaY or a composite particle or mixture of NaY or NaX and activated alumina; and a third layer of silicalite.

In a preferred embodiment the bed is used for the prepurification of air.

A preferred process of the invention comprises passing a feed gas containing propane through an adsorbent bed comprising at least two adsorbents wherein one of the adsorbents is silicalite.

In a preferred embodiment, the adsorbents can be in discrete layers, in a mixed layer, in a composite particle or in a combination of these.

### BRIEF DESCRIPTION OF THE DRAWINGS

Other objects, features and advantages will occur to those skilled in the art from the following description of preferred embodiments and the accompanying drawings, in which:

FIG. 1 is a schematic representation of a preferred adsorbent bed in accordance with the invention.

FIG. 2 illustrates propane breakthrough curves for a prior art adsorber versus an adsorber in accordance with the invention.

FIG. 3 illustrates CO₂ and propane breakthrough curves.

FIG. 4 is a schematic of an adsorption system useful in the practice of the invention.

### DETAILED DESCRIPTION OF THE INVENTION

The invention, in the preferred embodiment, relates to the removal of propane from feed air in an air separation plant through the use of a multilayered prepurifier. The inventive process and apparatus permits liquid oxygen (generated from the effluent from the prepurifier) to be boiled to dryness safely in the primary heat exchanger of a cryogenic air separation plant at pressures below 40 psig. In the most preferred embodiment of the invention, a multilayered adsorbent bed uses a layer of silicalite, preferably as a discrete top layer, to remove propane to a safe operating level of less than 0.1 ppm. Another embodiment of the invention is a multilayered adsorbent bed comprising activated alumina and CDX (40% NaY molecular sieve and 60% activated alumina) in an effective amount to reduce propane in air to at least 90%. Preferably the CDX layer is between about 30% to about 60% of the overall thickness. Another embodiment is a multilayered adsorbent comprising activated alumina and NaY in an effective amount to reduce propane in air to at least 90%. Preferably, the NaY layer is between about 30% to about 60% of the overall thickness.

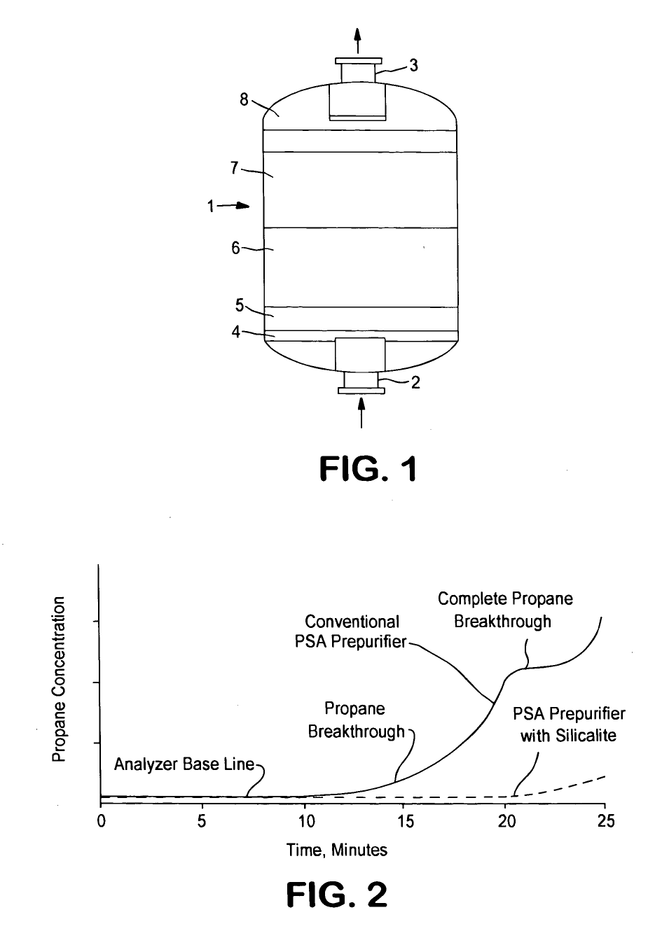

FIG. 1 illustrates a preferred embodiment of the invention. The arrows indicate the direction of gas flow through the bed with contaminated gas entering the adsorber vessel 1 through inlet 2 and purified gas exiting through outlet 3. As shown in FIG. 1, the bottom layer 4 consists of a layer of inert (e.g. ceramic) ball supports, which serve to support the bed and effectively distribute the flow of feed gas uniformly across the cross section of the bed. The layer 5 above the ball supports 4, is a layer of activated ball supports (ABS). This ABS layer 5 is comprised of a water selective adsorbent which is preferably activated alumina although silica gel may also be used. This layer 5 functions to ensure uniform distribution of gas across the cross section of the bed and to remove a substantial portion of the water entering the prepurifier.

Above ABS 5 is an additional layer 6 of activated alumina, a mixture of 13X/N₂O or 13X alone, for the removal of any remaining water, as well as carbon dioxide, and at least a portion of acetylene and/or other hydrocarbons that may be present in the feed.

Above the alumina layer 6, a layer 7 can be used which comprises NaX, NaY, a mixture of NaY/Alumina, or a composite NaY/Alumina adsorbent. Layer 7 is utilized for the removal of a portion of the propane as well as any of the other remaining hydrocarbon gases. The ratio of NaY/Alumina in the mixture or composite may be in the range of 5%/95% to 95%/5%, preferably between 10%/90% and 60%/40%. One preferred composite material is Selexorb CDX (available from Alcoa, Inc.) which has 40 per cent NaY molecular sieve and 60 per cent activated alumina.

The uppermost adsorbent layer 8 may comprise silicalite. The purpose of this uppermost layer is to adsorb propane as well as other light hydrocarbons remaining in the gas stream. The relative thickness of the silicalite layer depends upon the pressure, temperature, composition and flow of the feed gas and the desired purity of the purified gas, and these features can be determined by one of ordinary skill in the art. Typically, the thickness of the silicalite layer is preferred to be between about 2% and about 35% of the overall bed thickness, preferably between 3% and 20%, and most preferably between 5% and 15%.

The thickness of the alumina, NaY and/or the NaY/alumina composite or NaY/Alumina mixture layers also depends upon various factors such as the pressure, temperature, composition of and flow of the feed gas and the desired purity of the purified gas. As a non-limiting example, a bed was constructed for the removal of propane from a feed stream containing between 0.3 to 0.6 ppm propane and other impurities. In this bed, layer 5 was 9 inches thick, layers 6 and 7 were each 37.5 inches thick and the silicalite layer ranged from between six and nine inches thick depending on the concentration of propane in the feed. Preferably layer 5 could vary between 6 to 12 inches, layers 6 and 7 could vary between 34 to 42 inches and layer 8 could vary between about 5 and 12 inches.

For the purposes of propane removal, it is preferred in the practice of our invention to use a discrete layer of NaY adsorbent over layers of ABS and alumina. Less preferred embodiments may utilize either a layer of a NaY/alumina mixture or a layer of alumina/NaY composite adsorbent instead of the discrete NaY layer. The most preferred embodiment of our invention includes an ABS layer, an activated alumina layer, a NaY layer, and a silicalite layer, and this arrangement of components can result in the removal of more than 95% of the propane in the feed gas. A bed, with an ABS layer, an activated alumina layer and discrete NaY layer, was tested and removed 90% of the C₃H₈ with feed concentrations of 0.3 ppm and higher. At 0.3 ppm inlet concentration,the outlet concentration would be approximately 0.03 ppm. Adding a silicalite layer would increase the propane remove to higher removal efficiency i.e. 95%. To increase the removal efficiency more adsorbent can be added for a given flow providing the beds were regenerated properly so that the feed stream can achieve levels of less than 0.1 ppm propane. The less preferred embodiments disclosed above can still achieve removal of about 90% of the propane in the feed stream.

FIG. 2 presents breakthrough curves for propane in a multilayered bed with ABS/activated alumina/CDX compared to a multilayered bed with ABS/activated alumina/CDX/silicalite. The curve with the complete breakthrough is for the ABS/activated alumina/CDX bed and the curve with minimal breakthrough at the end of the cycle is for the ABS/activated alumina/CDX/silicalite bed. The ABS/activated alumina/CDX/silicalite bed removed >90% of the propane. Numerous tests were also run where the removal rate was >95%.

The prepurifier bed composed of ABS, activated alumina and CDX yields a propane breakthrough in slightly over 10 minutes as shown by a solid line, in FIG. 2. For the purpose of this comparison, breakthrough is defined as the appearance of 0.1 ppm propane in the effluent. In the case of the PSA prepurifier with silicates as shown by the dashed line, the partial breakthrough of propane takes place in approximately 20 minutes, and the increase in propane concentration is only slightly higher after 25 minutes indicating that complete breakthrough had not yet occurred. Conversely in the bed without silicalite, complete propane breakthrough takes place in approximately 20 minutes. The scale of the propane concentration is relative to the propane concentration in the plant air feed. Typical inlet concentrations of propane for the experiments ranged from 0.3 to 0.6 ppm. The long horizontal portion of the traces on the chart reflects the analytical base line of the other hydrocarbons in the purified air.

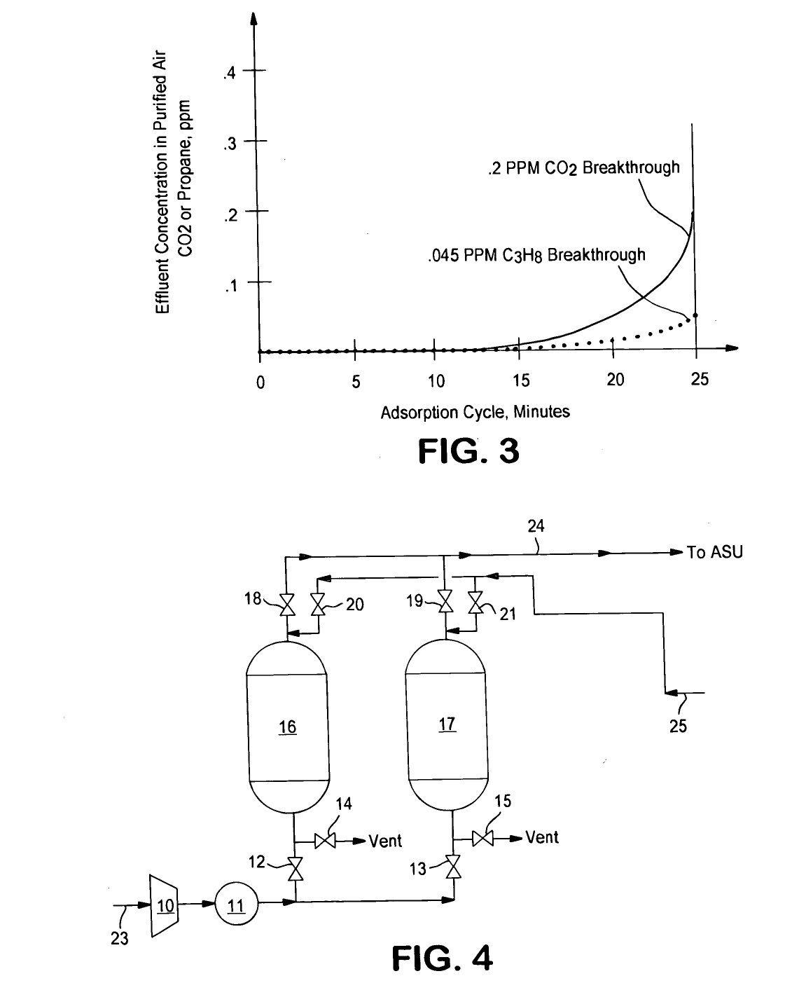

The adsorbent layer of silicalite presents a differential loading between propane and carbon dioxide. The results of this differential loading are shown in FIG. 3. In FIG. 3, the prepurifier feed contained 400 ppm carbon dioxide and 0.31 ppm propane. The breakthrough of carbon dioxide is in much greater evidence than that of propane. As shown on the graph, the breakthrough of carbon dioxide is 0.2 ppm whereas that for propane is only 0.045 ppm after 25 minutes of operation. Cycle time for one bed is normally about 20 to 25 minutes. In view of this, carbon dioxide breakthrough can be used as an indicator of hydrocarbon breakthrough.

The inventive arrangement utilizing the layer of silicalite at the top of the bed can remove greater than 95 per cent of the propane in the plant air feed when combined with a layered bed of alumina and NaY. This may be compared with the removal of only up to 71 per cent of the propane using a composite alumina/NaY layer without a silicalite layer. Raising the propane removal to 90 per cent or greater level permits safe operation of a plant when producing oxygen at pressures of 40 psig and below. It is noted that if you have very little propane in the feed, then the breakthrough would be less and possibly there would be no need for a silicalite layer.

In another less preferred embodiment, the amount of activated alumina in the bed may be increased (with the NaY layer being eliminated) and used with a discrete layer of silicalite. This embodiment is less preferred since alumina is less effective for the removal of propane.

In still another embodiment, silicalite adsorbent may be mixed or in a composite particle form with other adsorbents in the bed. Further, because silicalite is hydrophobic and organophilic the silicalite adsorption layer could be placed prior to or in the zone of the bed used for water removal. The choice of location and the amount of adsorbent required would depend on the components present in the feed stream.

The process is carried out preferably in a cyclic process such as pressure swing adsorption (PSA), vacuum swing adsorption (VSA) or a combination of these. The process of the invention may be carried out in single or multiple adsorption vessels operating in a cyclic process that includes at least the steps of adsorption and regeneration. The adsorption step is carried out at pressure range of 1.0 to 25 bar and preferentially from about 3 to 15 bar. The temperature range during the adsorption step is −70° C. to 80° C., preferably above 4° C. When a PSA process is used, the pressure during the regeneration step is lower than in the adsorption step and preferably in the range of about 0.10 to 5.0 bar, and preferably 0.1 to 0.3 bar. The method of the invention can be applied in horizontal, vertical or radial flow beds.

The method of regeneration for a PSA process is generally the vessel is countercurrent depressurization. Subatmospheric pressure levels can be additionally employed during the regeneration steps using a vacuum pump.

In some cases, passing an inert or weakly adsorbed purge gas countercurrently through the bed can further clean the adsorbent bed. In a PSA process, the purge step usually follows the countercurrent depressurization step. In case of a single vessel system, the purge gas can be introduced from a storage vessel, while for multiple bed system, purge gas can be obtained from another adsorber that is in the adsorption phase.

The adsorption system can have more steps than the two basic fundamental steps of adsorption and desorption. For example, top to top equalization or bottom to bottom equalization can be used to conserve energy and increase recovery.

In a sample embodiment the operation of a prepurification process is shown with reference to FIG. 4. Referring to FIG. 4, feed air fed to the system via conduit 23 is compressed in compressor 10 and cooled by chilling means 11 prior to entering one of two adsorbers 16 and 17 where at least the contaminants H₂O, CO₂ and propane are removed from the air. The purified air exits the adsorber via conduit 24 and then enters the air separation unit (ASU) (not shown) where it is then cryogenically separated into its major components N₂ and O₂. In special designs of the ASU, Ar, Kr and Xe may also be separated and recovered from the air. While one of the beds is adsorbing the contaminants from air, the other is being regenerated using purge gas provided via conduit 25. A dry, contaminant-free purge gas may be supplied from the product or waste stream from the ASU or from an independent source to desorb the adsorbed contaminants and thereby regenerate the adsorber and prepare it for the next adsorption step in the cycle. The purge gas may be N₂, O₂, a mixture of N₂ and O₂, air or any dry inert gas.

The operation of a typical PSA cycle is described in reference to FIG. 4. While the process will be described specifically for one adsorber vessel, one skilled in the art will appreciate that the other adsorber vessel will operate with the same cycle, only out of phase with the first adsorber in such a manner that purified air is continuously available to the ASU. Parenthetical references to the other bed and corresponding valves are also included below for clarity.

Feed air is introduced via conduit 23 to compressor 10 where it is pressurized. The heat of compression is removed in chilling means 11, e.g. a mechanical chiller or a combination of direct contact after-cooler and evaporative cooler. The pressurized, cool and H₂O-saturated feed stream then enters adsorber 16. Valve 12 is open and valves 14, 18 and 20 are closed as the adsorber vessel 16 is pressurized. When vessel 17 is pressurized, valve 13 is open while valves 15, 19 and 21 are closed. Once the adsorption pressure is reached, valve 18 (valve 19 when bed 17 has been pressurized) opens and purified product is directed to the ASU with conduit 25 for cryogenic air separation. When the adsorber 16 (17) has completed the adsorption step, valves 18 and 12 (19 and 13) are closed and valve 14 (15) is opened to blow down the adsorber 16 (17) to a lower pressure, typically near ambient pressure. Once depressurized, valve 20 (21) is opened and heated purge gas is introduced into the product end of the adsorber 16 (17).

One of ordinary skill in the art will further appreciate that the above description represents only an example of a typical prepurifier cycle, and there are many variations of such a typical cycle that may be used with the present invention. For example, pressurization may be accomplished with product gas, feed gas or a combination of the two. Bed-to-bed equalization may also be used and a blend step may be incorporated where a freshly regenerated bed is brought on line in the adsorption step with another adsorber nearing completion of its adsorption step. Such a blend step serves to smooth out pressure disturbances due to bed switching and also to minimize any thermal disturbances caused when the regenerated bed is not completely cooled to the feed temperature. Furthermore, the invention may be practiced with a prepurifier cycle not limited to two adsorber beds.

The use of silicalite may also result in the enhanced adsorption of other light hydrocarbon contaminants such as methane, ethane, butane, ethylene or propylene. In addition, the system and process of the invention is also applicable to other gas purification processes, such as post-purification processes, where propane or light hydrocarbon contaminants need to be removed from gases.

The adsorbent beds used in the method of the invention can have variety of configurations such as vertical beds, horizontal beds or radial beds and can be operated in a pressure swing adsorption mode, temperature swing adsorption mode, vacuum swing adsorption mode or a combination of these.

The adsorbents in this method may be shaped by a series of methods into various geometrical forms such as beads and extrudates. This might involve addition of a binder in ways very well known to prior art. These binders might also be necessary for tailoring the strength of the adsorbents. Binder types and shaping procedures are well known to prior art and the current invention does not put any constraints on the type and percentage amount of binders in the adsorbents.

Specific features of the invention are shown in one or more of the drawings for convenience only, as each feature may be combined with other features in accordance with the invention. Alternative embodiments will be recognized by those skilled in the art and are intended to be included within the scope of the claims.

1. An adsorbent bed comprising at least two adsorbents wherein at least two of the adsorbents are selected from the group consisting of silicalite with activated alumina, NaY with activated alumina and CDX with activated alumina.

2. The adsorbent bed of claim 1 wherein the silicalite is a layer having a thickness of between about 2% and about 35% of the overall bed thickness.

3. The adsorbent bed of claim 1 wherein at least one of said at least two adsorbents is selected from the group consisting of a discrete layer; a mixed layer; a composite particle layer and a combination thereof.

4. The adsorbent bed of claim 2 wherein another of the adsorbents within said bed is silica gel.

5. The adsorbent bed of claim 1 wherein the silicalite with activated alumina also contains CDX.

6. The adsorbent bed of claim 1 wherein said bed comprises a first layer of said activated alumina; a second layer selected from this group consisting of NaY, a composite particle of NaY and activated alumina, NaX, composite particle of NaX and activated alumina, and mixtures thereof; and a third layer of said silicalite.

7. The adsorbent bed of claim 6 wherein the first layer is between about 34 and 42 inches, the second layer is between about 34 and 42 inches, and the third layer is between about 6 and 12 inches.

8. The adsorbent bed of claim 1 wherein said adsorbent comprises NaY with activated alumina.

9. The adsorbent bed of claim 1 wherein said adsorbent comprises CDX with activated alumina.

10. The adsorbent bed of claim 1 wherein said bed is configured for either a vertical, horizontal or radial flow of a feed gas.

11. The adsorbent bed of claim 1 wherein said bed is adapted for use in prepurification of air by reducing propane in the air.

12. An adsorption process comprising passing a feed gas containing propane through at least one adsorbent bed comprising at least two adsorbents wherein at least two of the adsorbents are silicalite with activated alumina, NaY with activated alumina and CDX with activated alumina, and producing an effluent gas from said bed.

13. The adsorption process of claim 12 wherein said at least one of the adsorbents is selected from the group consisting of a discrete layer, a mixed layer, a composite particle and combination thereof.

14. The adsorption process of claim 12, wherein said bed comprises a first layer of activated alumina;, a second layer selected from the group consisting of NaX, a composite particle of NaX and activated alumina, NaY and a composite particle of NaY and activated alumina and mixtures thereof; and a third layer of said silicalite.

15. The adsorption process of claim 12 wherein said adsorbents are NaY with activated alumina.

16. The adsorption process of claim 12 wherein said adsorbents are CDX with activated alumina.

17. The adsorption process of claim 12, wherein said process is a temperature swing adsorption process, a pressure swing adsorption process or combination thereof.

18. The adsorption process of claim 12 wherein the feed gas is air and the effluent gas from said adsorber bed contains less than 0.1 ppm of propane.

19. The adsorption process of claim 12 wherein the silicalite is a layer having a thickness of between about 2% and about 35% of the overall bed thickness.

20. The adsorption process of claim 19 wherein the gas is air that contains propane and said propane is reduced by at least 90%.
